(19) United States
(12) Patent Application Publication
(10) Pub. No.: US 2005/0131856 A1
(43) Pub. Date: Jun. 16, 2005

(54) Method and system for adaptive user interfacing with an imaging system

(76) Inventor: Paul Joseph O'Dea, Muskego, WI (US)

Correspondence Address: MCANDREWS HELD & MALLOY, LTD, 500 WEST MADISON STREET, SUITE 3400, CHICAGO, IL, 60661, US

(21) Appl. No.: 10/737,646

(22) Filed: Dec. 15, 2003

(51) Int. Cl. G06F 7/00; G06F 17/30

(52) U.S. Cl. 707/1

(57) ABSTRACT

Certain embodiments of the present invention provide a method and system for adaptive user interfacing with an imaging system. The method includes recording actions taken during use of an imaging system, comparing the actions to settings stored in a profile, and updating the profile with at least one of the actions if at least one of the actions satisfies a criterion. Use of the imaging system may include configuration and/or operation of the imaging system. The profile may be based on one or more users and/or one or more operational modes. In an embodiment, the profile is update with one or more of the recorded actions if one or more of the recorded actions is more recently used and/or more frequently used than a setting stored in the profile. A user interface for the imaging system may be customized based on the profile.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to a user interface for an imaging system. In particular, the present invention relates to an adaptive user interface facilitating ease of control of an imaging system.

Imaging systems encompass a variety of imaging modalities, such as x-ray systems, computerized tomography (CT) systems, ultrasound systems, electron beam tomography (EBT) systems, magnetic resonance (MR) systems, and the like. Imaging systems generate images of an object, such as a patient, for example, through exposure to an energy source or wave, such as ultrasound beams traveling into a patient and producing echo signals reflected from bone and tissue inside the patient, for example. The generated images may be used for many purposes. For instance, internal defects in an object may be detected. Additionally, changes in internal structure or alignment may be determined. Fluid flow within an object may also be represented. Furthermore, the image may show the presence or absence of structures in an object.

The information gained from medical diagnostic imaging has applications in many fields, including medicine, manufacturing, and security. For example, imaging systems may be used for medical diagnosis and surgical navigation. Additionally, imaging systems may be used for safety and security applications, for example. Imaging systems may be used to help determine structural integrity of components as well.

Imaging systems are complicated to configure and to operate. Additionally, use of imaging systems involves training and preparation that may vary from user to user. Thus, a system and method that facilitate operation of an imaging system would be highly desirable. An operator of an ultrasound imaging system, for example, must configure and control the ultrasound system at a console while moving a transducer over an area of interest to obtain ultrasound image data. Therefore, a need exists for a system and method that improve ease of use and automation of an imaging system.

Many operators may use a single imaging system in a facility. Each operator of the imaging system may have different preferences and settings with which the imaging system is configured. For example, one technician typically uses an ultrasound system for color flow imaging, while another technician typically uses the same system for B-mode imaging. Additionally, an operator may scan a variety of patients or other objects during a given period. Each patient or object type may involve a different imaging system configuration. Time spent configuring and re-configuring an imaging system for different operators and/or different uses is wasteful and expensive. Thus, a system and method that allows multiple users to more easily share an imaging system would be highly desirable.

Additionally, system complexity and use by multiple operators for multiple purposes increases a likelihood that incorrect settings may remain between uses. Incorrect or erroneous settings may result in inaccurate images and incorrect diagnoses. Thus, there is a need for a system and method that minimizes a risk of incorrect settings between multiple users and multiple operations.

### BRIEF SUMMARY OF THE INVENTION

Certain embodiments of the present invention provide a method and system for adaptive user interfacing with an imaging system. Certain embodiments provide a method for customizing an imaging system control based on usage. The method includes recording actions taken during use of an imaging system, comparing the actions to settings stored in a profile, and updating the profile with at least one of the actions if at least one of the actions satisfies a criterion.

Use of the imaging system may include configuration and/or operation of the imaging system. The profile may be based on one or more users and/or one or more operational modes. In an embodiment, the profile is update with one or more of the recorded actions if one or more of the recorded actions is more recently used than a setting stored in the profile. Alternatively, the profile may be updated with one or more actions if one or more actions are more frequently used than one or more settings stored in the profile.

In an embodiment, an interface for the system is customized based on the profile. For example, one or more menu items in a user interface menu may be hidden or suppressed if the menu item(s) are not stored in the profile. A menu item or option may lead to the hidden items. Alternatively, for example, a tab, such as a touch panel tab, may be created including the settings stored in the profile.

The imaging system may also be configured according to the profile. In an embodiment, a sequence of actions may be stored as a setting in the profile. If the setting is selected through the user interface, the sequence of actions may be executed.

Certain embodiments provide an adaptive user interface system for imaging control. The system includes a tracking module for recording at least one of configuration information and operating functions used in an imaging system. The system also includes a profile including settings for the imaging system based on the at least one of configuration information and operating functions recorded by the tracking module, wherein the profile is stored according to a selection criterion. The system further includes a display for displaying a user interface for the imaging system, wherein the display arranges the user interface based on the profile.

The tracking module may update the profile based on the selection criterion. The selection criterion may include most recently used and/or most frequently used functions, for example. The profile may be based on at least one user and/or at least one operational mode. The user interface may include a user interface menu. One or more menu items that are not stored in the profile may be hidden or suppressed. For example, a user may indirectly reach menu items not stored in the profile. The user interface may also include a touch panel that includes settings stored in the profile.

Certain embodiments provide an imaging system for obtaining an image of an object. The imaging system includes a scanner for obtaining an image of an object and a user interface for controlling an imaging system. The user interface is adaptable based on user preferences. The user interface stores at least one profile based on the user preferences. The user interface is configured based on the profile. In an embodiment, the profile is updated based on a selection criterion. The selection criterion may include most recently used and/or most frequently used user preferences. In an embodiment, a sequence of actions is triggered in the imaging system based on selection of a setting in the profile. In an embodiment, a database search filter may be configured based on one or more settings in the profile.

### BRIEF DESCRIPTION OF SEVERAL VIEWS OF THE DRAWINGS

FIG. 1 illustrates a block diagram of an ultrasound imaging system used in accordance with an embodiment of the present invention.

FIG. 2 illustrates a flow diagram for a method for ultrasound imaging in accordance with an embodiment of the present invention.

FIG. 3 illustrates exemplary pull-down menus used in accordance with an embodiment of the present invention.

FIG. 4 illustrates an exemplary touch panel used in accordance with an embodiment of the present invention.

FIG. 5 depicts an exemplary user interface screen used in accordance with an embodiment of the present invention.

FIG. 6 illustrates a flow diagram for a method for adapting a system configuration to a certain user in accordance with an embodiment of the present invention.

FIG. 7 illustrates a flow diagram for a method for adapting a system configuration to a certain user in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide a control and interface system and method that may be used with a variety of imaging systems. For purposes of illustration only, certain embodiments will be described in relation to an ultrasound imaging system.

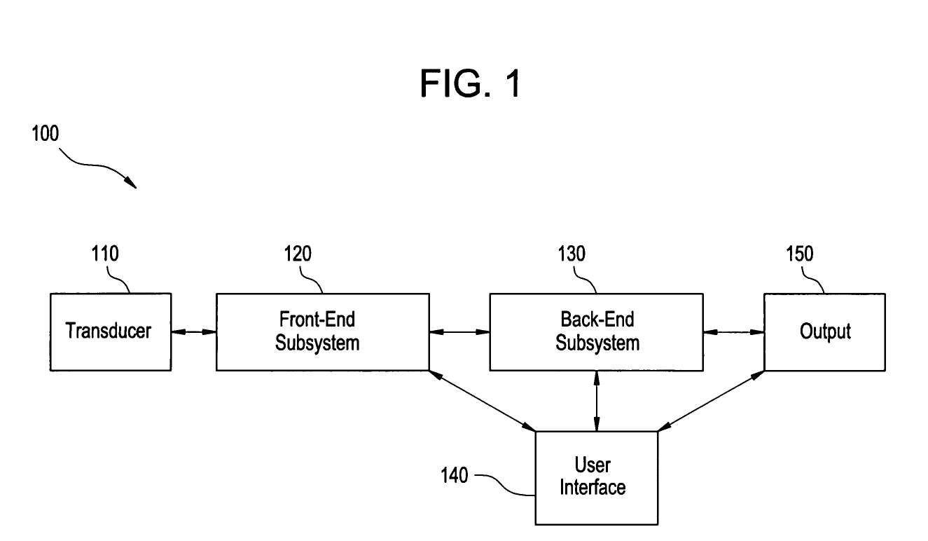

FIG. 1 illustrates a block diagram of an ultrasound imaging system 100 used in accordance with an embodiment of the present invention. The system 100 includes a transducer 110, a front-end subsystem 120, a back-end subsystem 130, a user interface 140, and an output 150. The back-end subsystem may include one or more imaging mode processors, such as a Doppler processor and/or a non-Doppler processor, and a control processor, for example. The front-end subsystem 120 may include a receiver, a transmitter, and one or more beamformers, for example.

The transducer 110 is used to transmit ultrasound waves into a subject by converting electrical analog signals to ultrasonic energy. The transducer 110 also is used to receive ultrasound waves that are backscattered from the subject by converting ultrasonic energy to electrical signals.

The front-end subsystem 120 is used to create transmitted waveforms, beam patterns, receiver filtering techniques, and demodulation schemes that are used for various imaging modes. The front-end subsystem 120 converts digital data to analog data and vice versa. The front-end subsystem 120 interfaces with the transducer 110 to transmit ultrasound beams and receive reflected echo signals. The front-end subsystem 120 interfaces with the back-end subsystem 130.

The processor(s) of the back-end subsystem 130 provide amplitude detection, data compression, and other processing for an imaging mode, such as B-mode imaging, M-mode imaging, BM-mode imaging, harmonic imaging, Doppler imaging, color flow imaging, and/or any other ultrasound imaging mode. The back-end subsystem 130 receives digital signal data from the front-end subsystem 120. The back-end subsystem 130 processes the received digital signal data to produce image data values. The image data values may be produced using the received digital signal data. The digital signal data may be analyzed in frequency bands centered at the fundamental, harmonics, and/or sub-harmonics, for example, of the transmitted signals to produce the image data values.

The digital image data values may then be processed using scan conversion functions, color mapping functions, compounding functions, and/or tissue/flow arbitration functions, for example. The back-end subsystem 130 processes, maps, and formats the digital image data and transmits image data to the output 150. The output 150 may display, store, and/or transmit the image data.

The user interface 140 allows user commands to be input by the operator to the ultrasound imaging system 100 through. The user interface 140 may include a keyboard, touch pad, mouse, switches, knobs, buttons, track ball, foot switches, and/or on screen menus, for example. In an embodiment, the user interface 140 may run on a computer and interface with the back-end subsystem 130 and/or the front-end subsystem 120. The back-end subsystem 130, the front-end subsystem 120, and/or the output 150 may also be implemented on a computer. An operator may configure and control the imaging system 100 via the user interface 140. For example, an operator may position a scan, set up imaging parameters, select an imaging mode, and/or process resulting image data using the user interface 140. In an alternative embodiment, the user interface 140 may be programmed to automatically execute defined imaging routines.

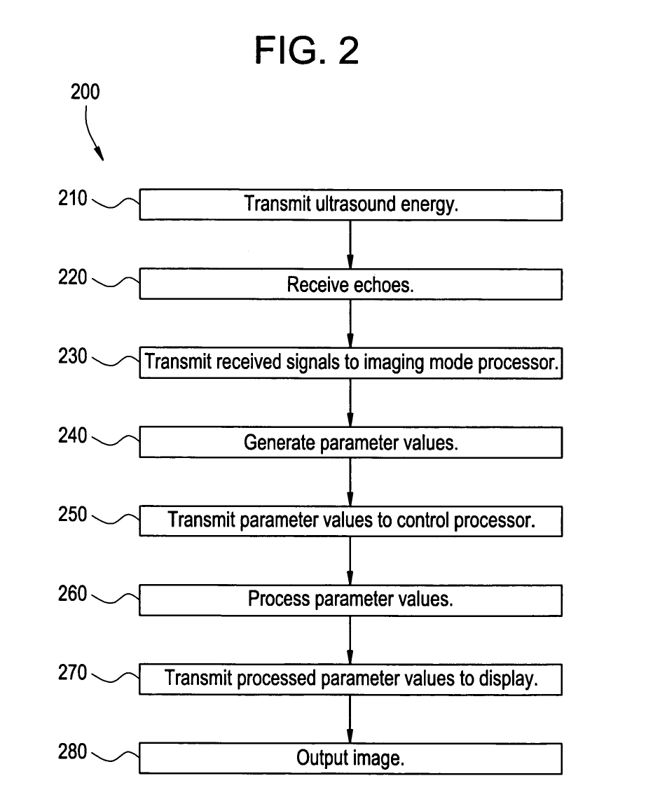

FIG. 2 illustrates a flow diagram for a method 200 for ultrasound imaging in accordance with an embodiment of the present invention. First, at step 210, an ultrasound beam is formed according to parameters, such as imaging mode and steering angle. Next, at step 220, the transducer 110 transmits ultrasound energy into a subject, such as a patient. Then, at step 230, ultrasound energy or echoes backscattered from the subject are received at the transducer 110. Signals are received at the front-end subsystem 120 in response to ultrasound waves backscattered from the subject.

Next, at step 240, the received signals are transmitted from the front-end subsystem 120 to the back-end subsystem 130. At step 250, the back-end subsystem 130 generates image data values based on the received signals. At step 260, the image data values are processed for use in display, storage, transmission, and diagnostics at the output 150.

Next, at step 270, processed image data values are transmitted to the output 150. Finally, at step 280, a diagnostic image is produced and output at the output 150. The image may be stored, displayed, printed, and/or further transmitted, for example. The output 150 may produce the diagnostic image using the processed digital signal data.

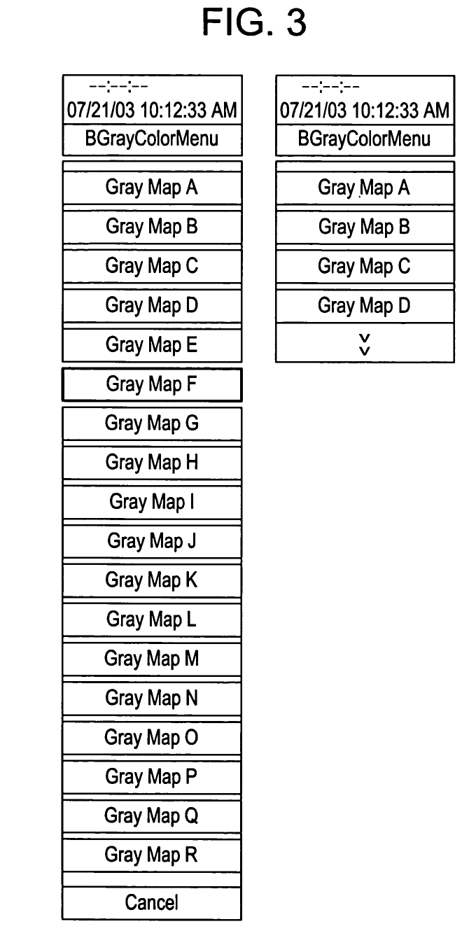

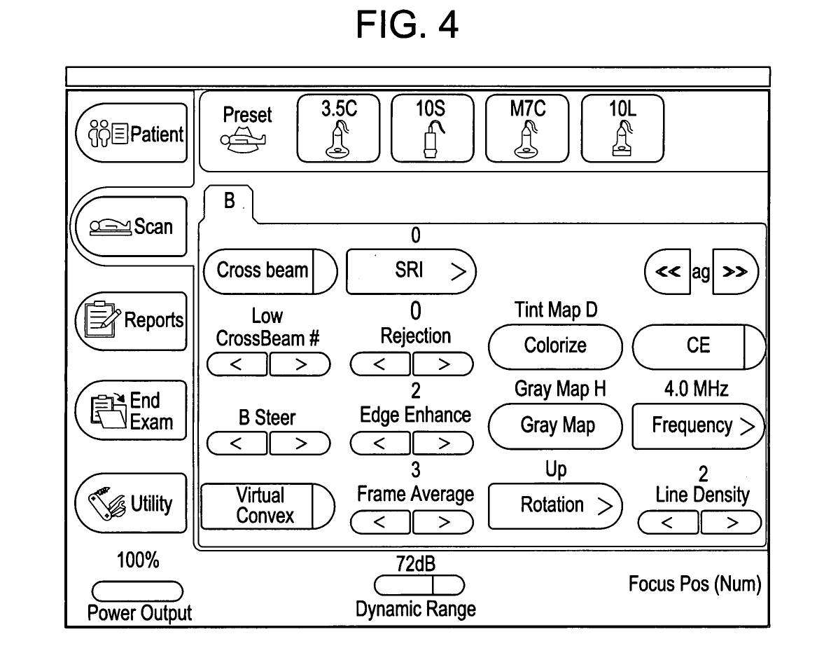

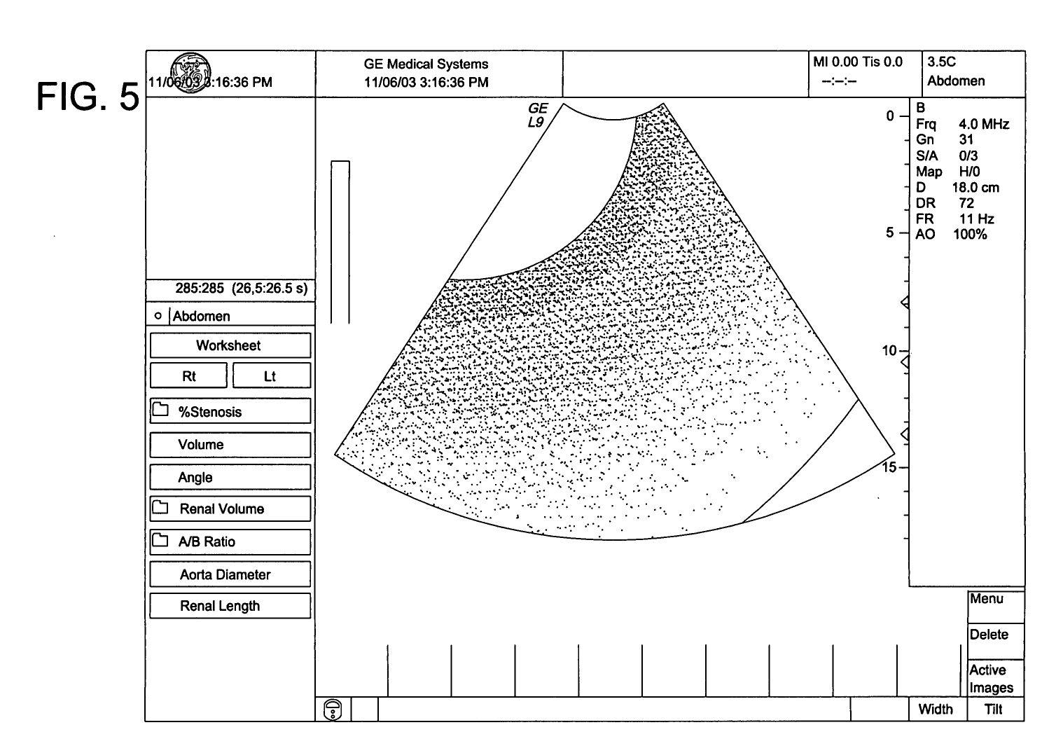

The user interface 140 may be used with the system 100 to execute an ultrasound imaging scan and configure system and imaging parameters. For example, an operator may select options from on-screen menus, such as a Microsoft Windows-based pull-down windows system. FIG. 3 illustrates exemplary pull-down menus used in accordance with an embodiment of the present invention. Alternatively, the user interface 140 may include a touch pad. A touch panel, such as the touch panel shown in FIG. 4, may be used to trigger and configure system 100 functions. In another embodiment, the user interface 140 may be a display including on-screen buttons clicked by a mouse, trackball, or other pointing device. FIG. 5 depicts an exemplary user interface screen used in accordance with an embodiment of the present invention.

In an embodiment, the user interface 140 and a control processor of the back-end subsystem 130 “learn” preferences and operational behavior for each operator that uses the system 100. Thus, the system 100 is customized for each operator. Customization of the system 100 and interface 140 may include smart menuing, a smart touch panel, smart database operations, smart protocol settings, smart presets, and/or configuring any setting that may vary from protocol to protocol or from operator to operator, for example.

In an embodiment, a smart menu, such as the smart menu shown on the right in FIG. 3, hides menu items that are infrequently used. The smart menu shows the menu items that have been recently used and hides the items that have not been recently used. The user interface 140 and/or back-end subsystem 130 tracks which menu options are frequently used by a particular operator and/or mode. Alternatively, the system 100 may track which menu options are frequently used by all operators and/or modes. For example, as shown in FIG. 3, Windows technology or another menu-driven system may be used to display a user's most used choices. More infrequently used choices are available by clicking on a double-arrow, for example.

In another embodiment, a smart touch panel, such as the touch panel shown in FIG. 4, includes a tab. The tab may be a new tab in addition to existing tabs on the touch panel or may be a reprogrammed existing tab. The tab includes buttons that are recently or more frequently used for a given operational mode and/or user. In an embodiment, standard touch pad tabs are available using standard navigation from a main smart touch pad tab. The tab including the most used buttons for a particular protocol may be displayed on top of other standard tabs. Tab order and options may change for different users and/or modes.

In another embodiment, smart database operations include automatic population of search filters, for example, based upon a most recently used search criteria for a given operator and/or mode. Smart database operations may also be based on most frequently used search criteria for a plurality of modes and/or operators.

In an embodiment, smart image adjustment settings may include remembering gain, focal zone, depth, and/or other parameters based on usage by particular operator(s) for particular protocol(s). Adjustment settings may be stored at the user interface 140 for one or more users based on most recent or most frequent usage, for example.

In another embodiment, smart presets include remembering preferred settings for one or more operators or imaging modes on any preset screen of the user interface 140. The most recently used items may be collected into a separate page similar to the tab on the touch panel, for example.

In an embodiment, settings are remembered in a Windows-based operating system. However, other operating systems, such as Linux, Unix, OS/2, or other operating system may be used. In an embodiment, options and settings are configured for a user and/or operational mode based on most recently used settings. Alternatively, settings may be configured and saved based on most frequently used settings for a user and/or operational mode. Any selection scheme may be used to store settings or parameters for user(s) and/or mode(s).

A table or other hardware or software structure in the user interface 140 or back-end subsystem 130 may be used to store data regarding user actions. Table 1 illustrates a table that may be used to store a certain number of most recently used options in accordance with an embodiment of the present invention. In an embodiment, the table stores user settings in order of most recent use. Thus, if a new option is selected, the new option replaces the least recently used or lowest entry in the table. For example, the table may be implemented as a first-in, first-out (FIFO) buffer. Addition of a new entry pushes the oldest entry out of the buffer and advances other existing entries to the next position in the buffer. Thus, addition of a new menu option removes a least recently used menu option from the table such that a certain number of entries are maintained in the table. Alternatively, the table may store user settings and an associated time of last use. A new entry may then replace a table entry with the least recent time of last use. Table entries are used by the user interface 140 to construct a graphical user interface display for a user.

TABLE 1

| System Setting | Time of Last Use |
|---|---|
| Frequency | 17:03; Nov. 12, 2003 |
| Focus | 08:00; Nov. 12, 2003 |
| Dynamic Range | 13:45; Nov. 01, 2003 |
| Time Resolution | 23:10; Oct. 20, 2003 |
| Sweep Speed | 10:03; Sep. 03, 2003 |

For example, the user interface 140 may track the last five menu options chosen by operator A when using the system 100. Then, the user interface 140 displays the last five options in an on-screen menu. Additional options are available after clicking for more options, such as clicking the double arrows shown in FIG. 3. The user interface 140 may store a different set of options for operator B. When operators A or B access the system 100 through the user interface 140, the appropriate settings appear on the user interface 140 screen.

Alternatively, for example, the user interface 140 may track a number of times settings are used within a given interval. Table 2 illustrates a table that may be used to store a certain number of most frequently used options in accordance with an embodiment of the present invention. If an option is used more than a certain threshold number of times, then the option is stored in a profile for a user and/or a mode. Different profiles may be stored for different users and/or operational modes. In an embodiment, a defined number of options may be stored for each profile. Other options may be available under a separate menu item or touch screen tab, for example. In an embodiment, an override is available to allow a user to manually configure a set of options to be prominently displayed.

TABLE 2

| System Setting | Frequency of Use |
|---|---|
| Frequency | 50 |
| Trace Method | 47 |
| Tint Map A | 33 |
| Gray Map D | 25 |
| Time Resolution | 10 |

The user interface 140 tracks which menu items are selected, which parameters are entered, which buttons are pressed, and/or which tabs are touched, for example. The user interface 140 may log user keystrokes and/or touches, for example. The user data is stored at the user interface 140 or the back-end subsystem 130. The user data is used to drive the user interface 140 display for a particular user and/or imaging mode.

In another embodiment, the user interface 140 may store a sequence of actions or settings for a user and/or protocol. The sequence may then be represented as a menu option, tab, or button for the user and/or protocol. Selecting the appropriate menu option, tab, or button triggers execution or configuration of the sequence. For example, operator A may prefer to execute a certain series of abdominal scans with varied parameters to check for abnormal growth. The series of scans and varied parameters may be stored such that the operator A selects a smart menu option to execute the series.

In an embodiment utilizing a most frequently used priority scheme, the user interface 140 records user actions/settings and stores the actions in a table or other such structure in the back-end subsystem 130 or user interface 140. A counter value is associated with each action. When a counter reaches a certain value, the action associated with the counter is added to a user or mode profile. The action may replace an action with a lower counter value. That is, the new frequently used item replaces an item that has become less frequently used. Counters associated with actions in the profile allow actions in the profile to be replaced by new actions that become more frequently used. In an embodiment, counters are refreshed after a certain interval has elapsed. For example, counters associated with actions are cleared after a month. Thus, a profile may be refreshed based on new patterns of usage.

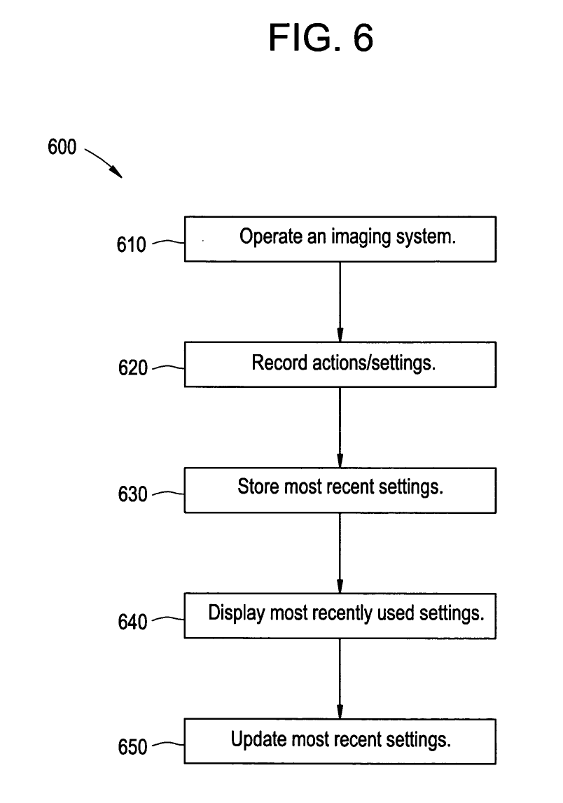

FIG. 6 illustrates a flow diagram for a method 600 for adapting an imaging system configuration to a certain user in accordance with an embodiment of the present invention. First, at step 610, a user uses an imaging system. For example, the user configures the ultrasound system 100 for a B-mode scan of a patient and executes the B-mode scan. At step 620, the user's actions are recorded. For example, keystrokes and menu selections of the user are recorded.

Then, at step 630, the user's most recent settings are stored with respect to the user. That is, a user profile may be created with a certain number of the user's most recent settings stored in the profile. Next, at step 640, when the user next operates the imaging system, the user's most recently used settings are displayed. That is, the user's most recently used settings are featured prominently on the user interface 140 so that the user may more easily use the system 100 to repeat previous functions. Then, at step 650, the user's actions are recorded to update the user's most recent settings. That is, the user's profile may be updated based on new most recently used settings.

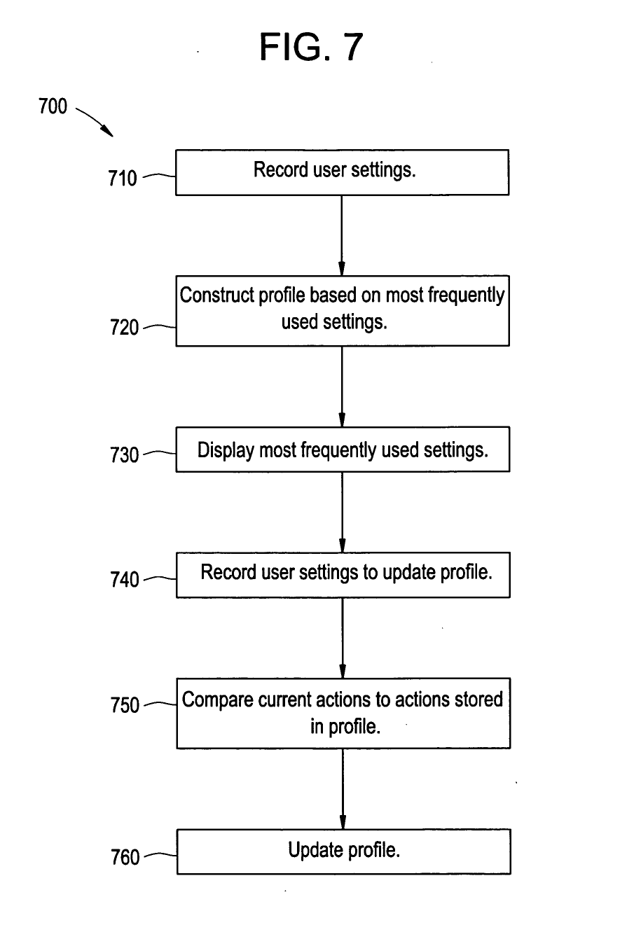

FIG. 7 illustrates a flow diagram for an alternative method 700 for adapting an imaging system configuration to a certain user in accordance with an embodiment of the present invention. First, at step 710, settings of an operator using an imaging system are recorded. For example, touch pad presses are stored by the user interface 140. Then, at step 720, a profile is constructed for the user based on the most frequently used settings or actions selected by the user. If an action or setting is selected more than a threshold number of times, then the action or setting is added to the user profile. The profile may be configured to accommodate a certain number of most frequently used settings.

Next, at step 730, when the user next operates the imaging system, the user's most frequently used settings are displayed. That is, the user's most frequently used settings are featured prominently on the user interface 140 so that the user may more easily use the system 100 to repeat typically used functions. Then, at step 740, the user's actions are recorded to update the user's most frequently used settings. That is, the user's profile may be updated based on newly recorded used settings. For example, a user's profile stores five most frequently used settings. The user has used the settings in the profile more than ten times within a week, for example.

At step 750, the user's actions are compared to actions stored in the user profile. During an imaging session, if a user selects a function that is not stored in the user's profile of most frequently used settings, a number of times that the function has been used within a given period is compared to usage numbers for functions in the user profile. Then, at step 760, the user profile is updated based on the user's actions. That is, if a new function has been used more often in a certain period than a function that is stored in the user profile, the new function replaces the old function in the user profile.

For example, a user configures settings for an ultrasound system, such as the system 100. The user may set scanning frequency, dynamic range, trace method, sweep speed, and color mapping, for example. The settings configured by the user are recorded at the user interface 140. Counters for the settings are incremented based on usage and/or time, for example. When the user returns to use the ultrasound system again, the settings may be loaded based on previous usage patterns. The system “remembers” the settings/functions/options that the user commonly uses when operating the system 100. Thus, when the user “logs on” to the system 100, the options for scanning frequency, dynamic range, trace method, sweep speed, and color mapping, for example, are prominently displayed at the user interface 140 for the particular user.

Alternatively, a profile may be created and tracked for multiple users. Profiles may also be created based on operational mode or protocol. For example, a profile may be created and updated for B-mode imaging. A user performing B-mode imaging on the ultrasound system 100 may select the B-mode imaging profile to display the most frequently or most recently used options for B-mode imaging on the user interface 140. Additionally, sequences of actions may be stored to be executed at the push of a button or selection of a menu option, tab, or other preset. Sequences may be updated based on subsequent user actions. Database operations, such as searches and filters, may also be customized based on user actions.

Thus, certain embodiments of the present invention allow any settings of an imaging system to be remembered and restored for one or more operators and/or protocols. Certain embodiments provide for easier-to-use and easier-to-configure imaging systems with flexibility for a plurality of users and operational modes. Certain embodiments provide increased productivity and reduced operator errors through stored settings and routines. Smart or remembered menus, buttons, and/or settings provide users with a familiar and comfortable environment. Certain embodiments minimize an amount of information an operator has to look at during an imaging session.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for customizing an imaging system control based on usage, said method comprising:
recording actions taken during use of an imaging system;
comparing said actions to settings stored in a profile; and
updating said profile with at least one of said actions if at least one of said actions satisfies a criterion.

2. The method of claim 1, wherein said use of said imaging system comprises at least one of configuration and operation of said imaging system.

3. The method of claim 1, wherein said profile is based on at least one user.

4. The method of claim 1, wherein said profile is based on at least one operational mode.

5. The method of claim 1, wherein said updating step further comprises updating said profile with at least one of said actions if at least one of said actions is more recently used than a setting stored in said profile.

6. The method of claim 1, wherein said updating step further comprises updating said profile with at least one of said actions if at least one of said actions is more frequently used than a setting stored in said profile.

7. The method of claim 1, further comprising customizing an interface for said imaging system based on said profile.

8. The method of claim 1, further comprising hiding at least one menu item in a user interface menu not stored in said profile.

9. The method of claim 1, further comprising creating a tab in a touch panel including said settings stored in said profile.

10. The method of claim 1, further comprising configuring said system according to said profile.

11. The method of claim 1, further comprising storing a sequence of actions as a setting in said profile.

12. An adaptive user interface system for imaging control, said system comprising:
a tracking module for recording at least one of configuration information and operating functions used in an imaging system;
a profile including settings for said imaging system based on said at least one of configuration information and operating functions recorded by said tracking module, wherein said profile is stored according to a selection criterion; and
a display for displaying a user interface for said imaging system, wherein said display arranges said user interface based on said profile.

13. The system of claim 12, wherein said tracking module updates said profile based on said selection criterion.

14. The system of claim 12, wherein said selection criterion includes at least one of most recently used functions and most frequently used functions.

15. The system of claim 12, wherein said profile is based on at least one user.

16. The system of claim 12, wherein said profile is based on at least one operational mode.

17. The system of claim 12, wherein said user interface further comprises a user interface menu, wherein at least one menu item not stored in said profile is hidden.

18. The system of claim 12, wherein said user interface further comprises a touch panel, said touch panel including said settings stored in said profile.

19. An imaging system for obtaining an image of an object, said imaging system comprising:
a scanner for obtaining an image of an object; and
a user interface for controlling an imaging system, wherein said user interface is adaptable based on user preferences, said user interface storing at least one profile based on said user preferences, wherein said user interface is configured based on said profile.

20. The imaging system of claim 19, wherein said profile is updated based on a selection criterion.

21. The imaging system of claim 20, wherein said selection criterion comprises at least one of most recently used user preferences and most frequently used user preferences.

22. The imaging system of claim 19, wherein a sequence of actions is triggered in said imaging system based on selection of a setting in said profile.

23. The imaging system of claim 19, wherein a database search filter is configured based on said profile.
